(19) United States
(12) Patent Application Publication
(10) Pub. No.: US 2009/0166588 A1
(43) Pub. Date: Jul. 2, 2009

(54) Petroleum Coke Compositions for Catalytic Gasification

(75) Inventors: Robert A. Spitz, Abington, MA (US); Alkis S. Rappas, Kingwood, TX (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GreatPoint Energy, Inc., Chicago, IL (US)

(21) Appl. No.: 12/342,565

(22) Filed: Dec. 23, 2008

Related U.S. Application Data
(60) Provisional application No. 61/017,296, filed on Dec. 28, 2007.

(51) Int. Cl. C10J 3/46; C09K 3/00

(52) U.S. Cl. 252/363.5; 48/202

(57) ABSTRACT

Particulate compositions are described comprising an intimate mixture of a petroleum coke, coal and a gasification catalyst, where the gasification catalyst is loaded onto at least the coal for gasification in the presence of steam to yield a plurality of gases including methane and at least one or more of hydrogen, carbon monoxide, and other higher hydrocarbons are formed. Processes are also provided for the preparation of the particulate compositions and converting the particulate composition into a plurality of gaseous products.

### CROSS-REFERENCE TO RELATED APPLICATIONS

This application claims priority under 35 U.S.C. §119 from U.S. Provisional Application Ser. No. 61/017,296 (filed Dec. 28, 2007), the disclosure of which is incorporated by reference herein for all purposes as if fully set forth.

### FIELD OF THE INVENTION

The present disclosure relates to particulate compositions of petroleum coke, coal, and at least one gasification catalyst. Further, the disclosure relates to processes for preparation of the particulate compositions and for gasification of the same in the presence of steam to form gaseous products, and in particular, methane.

### BACKGROUND OF THE INVENTION

In view of numerous factors such as higher energy prices and environmental concerns, the production of value-added gaseous products from lower-fuel-value carbonaceous feedstocks, such as petroleum coke and coal, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB1599932.

Petroleum coke is a generally solid carbonaceous residue derived from the delayed coking or fluid coking a carbon source such as a crude oil residue, and the coking processes used for upgrading oil sand. Petroleum cokes, in general, have poor gasification reactivity, particularly at moderate temperatures, due to their highly crystalline carbon and elevated levels of organic sulfur derived from heavy-gravity oil. Use of catalysts is necessary for improving the lower reactivity of petroleum cokes; however, certain catalysts can be poisoned by the sulfur-containing compounds in the petcokes. One advantageous catalytic process for gasifying petroleum cokes to methane and other value-added gaseous products is disclosed in the above-mentioned US2007/0083072A1.

The reaction of petroleum coke alone can have very high theoretical carbon conversion (e.g., 98%), but has its own challenges regarding maintaining bed composition, fluidization of the bed in the gasification reactor, control of possible liquid phases, and agglomeration of the bed in the gasification reactor and char withdrawal. Additionally, petroleum coke has inherently low moisture content, and a very low water soaking capacity to allow for conventional catalyst impregnation methods. Therefore, methods and compositions are needed which can support and provide a gasification catalyst for the gasification of petroleum coke.

### SUMMARY OF THE INVENTION

In one aspect, the present disclosure provides a particulate composition having a particle distribution size suitable for gasification in a fluidized bed zone, the particulate composition comprising an intimate mixture of (a) a petroleum coke; (b) a coal; and (c) a gasification catalyst which, in the presence of steam and under suitable temperature and pressure, exhibits gasification activity whereby a plurality of gases comprising methane and one or more of hydrogen, carbon monoxide, carbon dioxide, hydrogen sulfide, ammonia and other higher hydrocarbons are formed, wherein: (i) the petroleum coke and the coal are present in the particulate composition at a weight ratio of about 5:95 to about 95:5; (ii) the gasification catalyst is loaded onto at least the coal; (iii) the gasification catalyst comprises a source of at least one alkali metal and is present in an amount sufficient to provide, in the particulate composition, a ratio of alkali metal atoms to carbon atoms ranging from about 0.01 to about 0.08; and (iv) the particulate composition comprises a total ash content of less than about 20 wt %, based on the weight of the particulate composition.

In a second aspect, the present disclosure provides a process for converting a particulate composition into a plurality of gaseous products, comprising the steps of: (a) supplying a particulate composition according to first aspect to a gasifying reactor; (b) reacting the particulate composition in the gasifying reactor in the presence of steam and under suitable temperature and pressure to form a plurality of gaseous comprising methane and one or more of hydrogen, carbon monoxide, carbon dioxide, hydrogen sulfide, ammonia and other higher hydrocarbons; and (c) at least partially separating the plurality of gaseous products to produce a stream comprising a predominant amount of one of the gaseous products.

In a third aspect, the present disclosure provides a process for preparing a particulate composition of the first aspect comprising the steps of: (a) providing petroleum coke particulates, coal particulates and gasification catalyst; (b) contacting the coal particulates with an aqueous solution comprising a gasification catalyst to form a slurry; and (c) dewatering the slurry to form a catalyst-loaded wet coal cake; and (d) kneading the wet coal cake and the petroleum coke particulates to form the particulate composition.

### DETAILED DESCRIPTION

The present disclosure relates to a particulate composition, methods for the preparation of the particulate composition, and methods for the catalytic gasification of the particulate composition. Generally, the particulate composition includes one or more petroleum cokes in various blends with one or more coals, for example, high ash and/or high moisture content coals, particularly low ranking coals such as lignites, sub-bituminous coals, and mixtures thereof. Such particulate compositions can provide for an economical and commercially practical process for catalytic gasification of coals, such as lignites or sub-bituminous coal, with high ash and moisture contents to yield methane and other value-added gases as a product. Such particulate compositions also serve to reduce or eliminate some technical challenges associated with the catalytic gasification of petroleum coke. The particulate compositions and processes described herein identify methods to efficiently exploit these different feeds in a commercially practical gasification process by processing them as blended feedstock.

Recent developments to catalytic gasification technology are disclosed in commonly owned US2007/0000177A1, US2007/0083072A1 and US2007/0277437A1; and U.S. patent application Ser. No. 12/178,380 (filed 23 Jul. 2008), Ser. No. 12/234,012 (filed 19 Sep. 2008) and Ser. No. 12/234,018 (filed 19 Sep. 2008). Moreover, the processes of the present invention can be practiced in conjunction with the subject matter of the following U.S. patent applications, each of which was filed on even date herewith: Ser. No. ______, entitled “CONTINUOUS PROCESSES FOR CONVERTING CARBONACEOUS FEEDSTOCK INTO GASEOUS PRODUCTS” (attorney docket no. FN-0018 US NP1); Ser. No. ______, entitled “CATALYTIC GASIFICATION PROCESS WITH RECOVERY OF ALKALI METAL FROM CHAR” (attorney docket no. FN-0007 US NP1); Ser. No. ______, entitled “PETROLEUM COKE COMPOSITIONS FOR CATALYTIC GASIFICATION” (attorney docket no. FN-0011 US NP1); Ser. No. ______, entitled “CARBONACEOUS FUELS AND PROCESSES FOR MAKING AND USING THEM” (attorney docket no. FN-0013 US NP1); Ser. No. ______, entitled “CATALYTIC GASIFICATION PROCESS WITH RECOVERY OF ALKALI METAL FROM CHAR” (attorney docket no. FN-0014 US NP1); Ser. No. ______, entitled “COAL COMPOSITIONS FOR CATALYTIC GASIFICATION” (attorney docket no. FN-0009 US NP1); Ser. No. ______, entitled “PROCESSES FOR MAKING SYNTHESIS GAS AND SYNGAS-DERIVED PRODUCTS” (attorney docket no. FN-0010 US NP1); Ser. No. ______, entitled “CATALYTIC GASIFICATION PROCESS WITH RECOVERY OF ALKALI METAL FROM CHAR” (attorney docket no. FN-0015 US NP1); Ser. No. ______, entitled “CATALYTIC GASIFICATION PROCESS WITH RECOVERY OF ALKALI METAL FROM CHAR” (attorney docket no. FN-0016 US NP1); Ser. No. ______, entitled “STEAM GENERATING SLURRY GASIFIER FOR THE CATALYTIC GASIFICATION OF A CARBONACEOUS FEEDSTOCK” (attorney docket no. FN-0017 US NP1); and Ser. No. ______, entitled “PROCESSES FOR MAKING SYNGAS-DERIVED PRODUCTS” (attorney docket no. FN-0012 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Although methods and materials similar or equivalent to those described herein can be used in the practice or testing of the present disclosure, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The materials, methods, and examples herein are illustrative only and, except as specifically stated, are not intended to be limiting.

### Petroleum Coke

The term “petroleum coke” as used herein includes both (i) the solid thermal decomposition product of high-boiling hydrocarbon fractions obtained in petroleum processing (heavy residues—“resid petcoke”); and (ii) the solid thermal decomposition product of processing tar sands (bituminous sands or oil sands—“tar sands petcoke”). Such carbonization products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % or less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as silica and/or alumina.

Petroleum coke in general has an inherently low moisture content typically in the range of from about 0.2 to about 2 wt %. (based on total petroleum coke weight); it also typically has a very low water soaking capacity to allow for conventional catalyst impregnation methods. The particulate composition of this disclosure eliminates this problem and uses the low moisture content in the petroleum coke for advantageous effects in a petroleum coke-coal blends. The resulting particulate compositions contain, for example, a lower average moisture content which increases the efficiency of downstream drying operation versus conventional drying operations.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

### Coal

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on the total coal weight. Examples of useful coals include, but are not limited to, Illinois #6, Pittsburgh #8, Beulah (N. Dak.), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art. See, for example, “Coal Data: A Reference”, Energy Information Administration, Office of Coal, Nuclear, Electric and Alternate Fuels, U.S. Department of Energy, DOE/EIA-0064(93), February 1995.

The ash produced from a coal typically comprises both a fly ash and a bottom ash, as are familiar to those skilled in the art. The fly ash from a bituminous coal can comprise from about 20 to about 60 wt % silica and from about 5 to about 35 wt % alumina, based on the total weight of the fly ash. The fly ash from a sub-bituminous coal can comprise from about 40 to about 60 wt % silica and from about 20 to about 30 wt % alumina, based on the total weight of the fly ash. The fly ash from a lignite coal can comprise from about 15 to about 45 wt % silica and from about 20 to about 25 wt % alumina, based on the total weight of the fly ash. See, for example, Meyers, et al., “Fly Ash. A Highway Construction Material”, Federal Highway Administration, Report No. FHWA-IP-76-16, Washington, D.C., 1976.

The bottom ash from a bituminous coal can comprise from about 40 to about 60 wt % silica and from about 20 to about 30 wt % alumina, based on the total weight of the bottom ash. The bottom ash from a sub-bituminous coal can comprise from about 40 to about 50 wt % silica and from about 15 to about 25 wt % alumina, based on the total weight of the bottom ash. The bottom ash from a lignite coal can comprise from about 30 to about 80 wt % silica and from about 10 to about 20 wt % alumina, based on the total weight of the bottom ash. See, for example, Moulton, Lyle K, “Bottom Ash and Boiler Slag”, Proceedings of the Third International Ash Utilization Symposium, U.S. Bureau of Mines, Information Circular No. 8640, Washington, D.C., 1973.

### Catalyst Components

Particulate compositions according to the present disclosure are based on the above-described petroleum coke and coal and further comprise an amount of an alkali metal component, as alkali metal and/or a compound containing alkali metal.

The alkali metal component is typically loaded onto at least the coal component of the particulate compositions to achieve an alkali metal content of from about 3 to about 10 times more than the combined ash content of the petroleum coke and coal, on a mass basis.

Suitable alkali metals are lithium, sodium, potassium, rubidium, cesium, and mixtures thereof. Particularly useful are potassium sources. Suitable alkali metal compounds include alkali metal carbonates, bicarbonates, formates, oxalates, amides, hydroxides, acetates, or similar compounds. For example, the catalyst can comprise one or more of sodium carbonate, potassium carbonate, rubidium carbonate, lithium carbonate, cesium carbonate, sodium hydroxide, potassium hydroxide, rubidium hydroxide or cesium hydroxide, and particularly, potassium carbonate and/or potassium hydroxide.

Co-catalysts or other catalyst additives may also be utilized, such as disclosed in the previously incorporated references.

### Particulate Composition

Typically, each of the petroleum coke and coal sources can be supplied as a fine particulate having an average particle size of from about 25 microns, or from about 45 microns, up to about 2500 microns, or up to about 500 microns. One skilled in the art can readily determine the appropriate particle size for the individual particulates and the particulate composition. For example, when a fluid bed gasification reactor is used, the particulate composition can have an average particle size which enables incipient fluidization of the particulate composition at the gas velocity used in the fluid bed gasification reactor.

At least the coal particulate of the particulate composition comprises a gasification catalyst and optionally, a co-catalyst/catalyst additive as discussed previously. Typically, the gasification catalyst can comprise a source of at least one alkali metal and is present in an amount sufficient to provide, in the particulate composition, a ratio of alkali metal atoms to carbon atoms ranging from about 0.01, or from about 0.02, or from about 0.03, or from about 0.04, to about 0.08, or to about 0.07, or to about 0.06.

The ratio of the petroleum coke particulate and coal particulate in the particulate composition can be selected based on technical considerations, processing economics, availability, and proximity of the coal and petroleum coke sources. The availability and proximity of the two sources for these blends affect the price of the feeds, and thus the overall production costs of the catalytic gasification process. For example, the petroleum coke and the coal can be blended in at about 5:95, about 10:90, about 15:85, about 20:80, about 25:75, about 30:70, about 35:65, about 40:60, about 45:55, about 50:50, about 55:45, about 60:40, about 65:35, about 70:20, about 75:25, about 80:20, about 85:15, about 90:10, or about 95:5 by weight on a wet or dry basis, depending on the processing conditions.

More significantly, the petroleum coke and coal sources, as well as the ratio of the petroleum coke particulate to the coal particulate, can be used to control other material characteristics of the feedstock blend.

Typically, coal and other carbonaceous material include significant quantities of inorganic mater including calcium, alumina and silica which form inorganic oxides (“ash”) in the gasification reactor. At temperatures above about 500 to 600° C., potassium and other alkali metals can react with the alumina and silica in ash to form insoluble alkali aluminosilicates. In this form, the alkali metal is substantially water-insoluble and inactive as a catalyst. To prevent buildup of the residue in a coal gasification reactor, a solid purge of char, i.e., solids composed of ash, unreacted carbonaceous material, and various alkali metal compounds (both water soluble and water insoluble) are routinely withdrawn. Preferably, the alkali metal is recovered from the char, and any unrecovered catalyst is generally compensated by a catalyst make-up stream. The more alumina and silica that is in the feedstock, the more costly it is to obtain a higher alkali metal recovery.

By preparing the particulate compositions in accordance with the resent invention, the ash content of the particulate composition can be selected to be, for example, to be about 20 wt % or less, or about 15 wt % or less, or about 10 wt % or less, depending on ratio of the particulates and/or the starting ash in the coal source. In other embodiments, the resulting particulate composition can comprise an ash content ranging from about 5 wt %, or from about 10 wt %, to about 20 wt %, or to about 15 wt %, based on the weight of the particulate composition. In other embodiments, the ash content of the particulate composition can comprise less than about 20 wt %, or less than about 15 wt %, or less than about 10 wt %, or less than about 8 wt %, or less than about 6 wt % alumina, based on the weight of the ash. In certain embodiments, the resulting particulate composition can comprise an ash content of less than about 20 wt %, based on the weight of the particulate composition, wherein the ash content of the particulate composition comprises less than about 20 wt % alumina, or less than about 15 wt % alumina, based on the weight of the ash.

Such lower alumina values in the particulate composition allow for decreased losses of alkali catalysts in the gasification process. Typically, alumina can react with alkali source to yield an insoluble char comprising, for example, an alkali aluminate or aluminosilicate. Such insoluble char can lead to decreased catalyst recovery (i.e., increased catalyst loss), and thus, require additional costs of make-up catalyst in the overall gasification process, as will be discussed later.

Additionally, the resulting particulate composition can have a significantly higher % carbon, and thus btu/lb value and methane product per unit weight of the particulate composition. In certain embodiments, the resulting particulate composition has a carbon content ranging from about 75 wt %, or from about 80 wt %, or from about 85 wt %, or from about 90 wt %, up to about 95 wt %, based on the combined weight of the coal and petcoke.

### Methods for Making the Particulate Composition

The petroleum coke and coal sources for use in the preparation of the particulate composition can require initial processing to prepare the particulate composition for gasification. For example, when using a particulate composition comprising a mixture of two or more carbonaceous materials, such as petroleum coke and coal, the petroleum coke and coal can be separately processed to add catalyst to at least the coal portion, and subsequently mixed.

The petroleum coke and coal sources for the particulate composition can be crushed and/or ground separately according to any methods known in the art, such as impact crushing and wet or dry grinding to yield particulates of each. Depending on the method utilized for crushing and/or grinding of the petroleum coke and coal materials, the resulting particulates can need to be sized (i.e., separated according to size) to provide an appropriate feedstock.

Any method known to those skilled in the art can be used to size the particulates. For example, sizing can be preformed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the petroleum coke and coal particulates. Classification equipment can include ore sorters, gas cyclones, hydrocyclones, rake classifiers, rotating trommels, or fluidized classifiers. The petroleum coke and coals can be also sized or classified prior to grinding and/or crushing.

Additional feedstock processing steps may be necessary depending on the qualities of petroleum coke and coal sources. High-moisture coals can require drying prior to crushing. Some caking coals can require partial oxidation to simplify gasification reactor operation. Coal feedstocks deficient in ion-exchange sites can be pre-treated to create additional ion-exchange sites to facilitate catalysts loading and/or association. Such pre-treatments can be accomplished by any method known to the art that creates ion-exchange capable sites and/or enhances the porosity of the feedstock (see, for example, previously incorporated U.S. Pat. No. 4,468,231 and GB1599932). Often, pre-treatment is accomplished in an oxidative manner using any oxidant known to the art.

Typically, the coal is wet ground and sized (e.g., to a particle size distribution of 25 to 2500 microns) and then drained of its free water (i.e., dewatered) to a wet cake consistency. Examples of suitable methods for the wet grinding, sizing, and dewatering are known to those skilled in the art, as disclosed in previously incorporated U.S. patent application Ser. No. 12/178,380 (filed 23 Jul. 2008).

The filter cake of the coal particulate formed by the wet grinding in accordance with one embodiment of the present disclosure can have a moisture content ranging from about 40% to about 60%, about 40% to about 55%, or below 50%. It will be appreciated by one of ordinary skill in the art that the moisture content of dewatered wet ground coal depends on the particular type of coal, the particle size distribution, and the particular dewatering equipment used.

The coal particulate is subsequently treated to associate at least a first catalyst (e.g., gasification catalyst) therewith. In some cases, a second catalytic component (e.g., co-catalyst) can be provided to the coal particulate; in such instances, the coal particulate can be treated in separate processing steps to provide the first catalyst and second catalysts. For example, the primary gasification catalyst can be supplied to the coal particulate (e.g., a potassium and/or sodium source), followed by a separate treatment to provide a calcium gasification co-catalyst source to the coal. Alternatively, the first and second catalysts can be provided as a mixture in a single treatment (see previously incorporated US2007/0000177A1).

Any methods known to those skilled in the art can be used to associate one or more gasification catalysts with the coal particulate. Such methods include but are not limited to, admixing with a solid catalyst source and impregnating the catalyst on to coal particulate. Several impregnation methods known to those skilled in the art can be employed to incorporate the gasification catalysts. These methods include but are not limited to, incipient wetness impregnation, evaporative impregnation, vacuum impregnation, dip impregnation, ion exchanging, and combinations of these methods. Gasification catalysts can be impregnated into the coal particulate by slurrying with a solution (e.g., aqueous) of the catalyst.

When the coal particulate is slurried with a solution of the catalyst and/or co-catalyst, the resulting slurry can be dewatered to provide a catalyzed coal particulate, again typically, as a wet cake. The catalyst solution for slurrying the coal particulate can be prepared from any catalyst source in the present methods, including fresh or make-up catalyst and recycled catalyst or catalyst solution (infra). Methods for dewatering the slurry to provide a wet cake of the catalyzed coal particulate include filtration (gravity or vacuum), centrifugation, and a fluid press.

One particular method suitable for combining the coal particulate with a gasification catalyst to provide a catalyzed carbonaceous feedstock where the catalyst has been associated with the coal particulate via ion exchange is described in previously incorporated U.S. patent application Ser. No. 12/178,380 (filed 23 Jul. 2008). The catalyst loading by ion exchange mechanism is maximized (based on adsorption isotherms specifically developed for the coal), and the additional catalyst retained on wet including those inside the pores is controlled so that the total catalyst target value is obtained in a controlled manner. Such loading provides a catalyzed coal particulate as a wet cake. The catalyst loaded and dewatered wet coal cake typically contains, for example, about 50% moisture. The total amount of catalyst loaded is controlled by controlling the concentration of catalyst components in the solution, as well as the contact time, temperature and method, as can be readily determined by those of ordinary skill in the relevant art based on the characteristics of the starting coal.

Alternatively, the slurried coal particulate can be dried with a fluid bed slurry drier (i.e., treatment with superheated steam to vaporize the liquid), or the solution evaporated, to provide a dry catalyzed coal particulate.

The catalyst-loaded coal compositions typically comprise greater than about 50%, greater than about 70%, greater than about 85%, or greater than about 90% of the total amount of catalyst loaded associated with the coal matrix, for instance, as ion-exchanged catalyst on the acidic functional groups of the coal. The percentage of total loaded catalyst that is associated with the coal particulate can be determined according to methods known to those skilled in the art.

The separate petroleum coke particulate and catalyzed coal particulate can be combined appropriately to control, for example, the total catalyst loading or other qualities of the particulate composition, as discussed previously. The appropriate ratios of the separate particulates will depend on the qualities of the feedstocks as well as the desired properties of the particulate composition. For example, the petroleum coke particulate and the catalyzed coal particulate can be combined in such a ratio to yield a particulate composition having a predetermined ash content, as discussed previously.

The separate petroleum coke particulate and the catalyzed coal particulate can be combined by any methods known to those skilled in the art including, but not limited to, kneading, and vertical or horizontal mixers, for example, single or twin screw, ribbon, or drum mixers. The particulate composition can be stored for future use or transferred to a feed operation for introduction into a gasification reactor. The particulate composition can be conveyed to storage or feed operations according to any methods known to those skilled in the art, for example, a screw conveyer or pneumatic transport.

### Catalytic Gasification Methods

The particulate compositions of the present disclosure are particularly useful in integrated gasification processes for converting petroleum coke and coal to combustible gases, such as methane. The gasification reactors for such processes are typically operated at high pressures and temperature, requiring introduction of the particulate composition to the reaction zone of the gasification reactor while maintaining the required temperature, pressure, and flow rate of the feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

In some instances, the particulate composition can be prepared at pressures conditions above the operating pressure of gasification reactor. Hence, the particulate composition can be directly passed into the gasification reactor without further pressurization.

Suitable gasification reactors include counter-current fixed bed, co-current fixed bed, fluidized bed, entrained flow, and moving bed reactors.

The particulate compositions are particularly useful for gasification at moderate temperatures of at least about 450° C., or of at least about 600° C. or above, to about 900° C., or to about 750° C., or to about 700° C.; and at pressures of at least about 50 psig, or at least about 200 psig, or at least about 400 psig, to about 1000 psig, or to about 700 psig, or to about 600 psig.

The gas utilized in the gasification reactor for pressurization and reactions of the particulate composition typically comprises steam, and optionally, oxygen or air, and are supplied to the reactor according to methods known to those skilled in the art. For example, any of the steam boilers known to those skilled in the art can supply steam to the reactor. Such boilers can be powered, for example, through the use of any carbonaceous material such as powdered coal, biomass etc., and including but not limited to rejected carbonaceous materials from the particulate composition preparation operation (e.g., fines, supra). Steam can also be supplied from a second gasification reactor coupled to a combustion turbine where the exhaust from the reactor is thermally exchanged to a water source and produce steam.

Recycled steam from other process operations can also be used for supplying steam to the reactor. For example, when the slurried particulate composition is dried with a fluid bed slurry drier, as discussed previously, the steam generated through vaporization can be fed to the gasification reactor.

The small amount of required heat input for the catalytic coal gasification reaction can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the gasification reactor effluent followed by superheating in a recycle gas furnace.

A methane reformer can be included in the process to supplement the recycle carbon monoxide and hydrogen fed to the reactor to ensure that the reaction is run under thermally neutral (adiabatic) conditions. In such instances, methane can be supplied for the reformer from the methane product, as described below.

Reaction of the particulate composition under the described conditions typically provides a crude product gas and a char. The char produced in the gasification reactor during the present processes typically is removed from the gasification reactor for sampling, purging, and/or catalyst recovery. Methods for removing char are well known to those skilled in the art. One such method taught by EP-A-0102828, for example, can be employed. The char can be periodically withdrawn from the gasification reactor through a lock hopper system, although other methods are known to those skilled in the art. Processes have been developed to recover alkali metal from the solid purge in order to reduce raw material costs and to minimize environmental impact of a catalytic gasification process.

The char can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512, US2007/0277437A1, U.S. patent application Ser. No. ______, entitled “CATALYTIC GASIFICATION PROCESS WITH RECOVERY OF ALKALI METAL FROM CHAR” (attorney docket no. FN-0007 US NP1), U.S. patent application Ser. No. ______, entitled “CATALYTIC GASIFICATION PROCESS WITH RECOVERY OF ALKALI METAL FROM CHAR” (attorney docket no. FN-0014 US NP1), U.S. patent application Ser. No. ______, entitled “CATALYTIC GASIFICATION PROCESS WITH RECOVERY OF ALKALI METAL FROM CHAR” (attorney docket no. FN-0015 US NP1), and U.S. patent application Ser. No. ______, entitled “CATALYTIC GASIFICATION PROCESS WITH RECOVERY OF ALKALI METAL FROM CHAR” (attorney docket no. FN-0016 US NP1). Reference can be had to those documents for further process details.

Crude product gas effluent leaving the gasification reactor can pass through a portion of the gasification reactor which serves as a disengagement zone where particles too heavy to be entrained by the gas leaving the gasification reactor (i.e., fines) are returned to the fluidized bed. The disengagement zone can include one or more internal cyclone separators or similar devices for removing fines and particulates from the gas. The gas effluent passing through the disengagement zone and leaving the gasification reactor generally contains CH₄, CO₂, H₂ and CO, H₂S, NH₃, unreacted steam, entrained fines, and other contaminants such as COS.

The gas stream from which the fines have been removed can then be passed through a heat exchanger to cool the gas and the recovered heat can be used to preheat recycle gas and generate high pressure steam. Residual entrained fines can also be removed by any suitable means such as external cyclone separators followed by Venturi scrubbers. The recovered fines can be processed to recover alkali metal catalyst.

The gas stream exiting the Venturi scrubbers can be fed to COS hydrolysis reactors for COS removal (sour process) and further cooled in a heat exchanger to recover residual heat prior to entering water scrubbers for ammonia recovery, yielding a scrubbed gas comprising at least H₂S, CO2, CO, H₂, and CH₄. Methods for COS hydrolysis are known to those skilled in the art, for example, see U.S. Pat. No. 4,100,256.

The residual heat from the scrubbed gas can be used to generate low pressure steam. Scrubber water and sour process condensate can be processed to strip and recover H₂S, CO₂ and NH₃; such processes are well known to those skilled in the art. NH₃ can typically be recovered as an aqueous solution (e.g., 20 wt %).

A subsequent acid gas removal process can be used to remove H₂S and CO₂ from the scrubbed gas stream by a physical absorption method involving solvent treatment of the gas to give a cleaned gas stream. Such processes involve contacting the scrubbed gas with a solvent such as monoethanolamine, diethanolamine, methyldiethanolamine, diisopropylamine, diglycolamine, a solution of sodium salts of amino acids, methanol, hot potassium carbonate or the like. One method can involve the use of Selexol® (UOP LLC, Des Plaines, Ill. USA) or Rectisol® (Lurgi AG, Frankfurt am Main, Germany) solvent having two trains; each train consisting of an H₂S absorber and a CO₂ absorber. The spent solvent containing H₂S, CO₂ and other contaminants can be regenerated by any method known to those skilled in the art, including contacting the spent solvent with steam or other stripping gas to remove the contaminants or by passing the spent solvent through stripper columns. Recovered acid gases can be sent for sulfur recovery processing. The resulting cleaned gas stream contains mostly CH₄, H₂, and CO and, typically, small amounts of CO₂ and H₂O. Any recovered H₂S from the acid gas removal and sour water stripping can be converted to elemental sulfur by any method known to those skilled in the art, including the Claus process. Sulfur can be recovered as a molten liquid.

The cleaned gas stream can be further processed to separate and recover CH₄ by any suitable gas separation method known to those skilled in the art including, but not limited to, cryogenic distillation and the use of molecular sieves or ceramic membranes. One method for recovering CH₄ from the cleaned gas stream involves the combined use of molecular sieve absorbers to remove residual H₂O and CO₂ and cryogenic distillation to fractionate and recover CH₄. Typically, two gas streams can be produced by the gas separation process, a methane product stream and a syngas stream (H₂ and CO). The syngas stream can be compressed and recycled to the gasification reactor. If necessary, a portion of the methane product can be directed to a reformer, as discussed previously and/or a portion of the methane product can be used as plant fuel.

The processes described herein can advantageously use, for example, high ash lignites that otherwise would be technically difficult and uneconomical to operate. Treating lignite alone would have very low specific (i.e. value per unit weight) carbon conversion, and very high catalyst dosage with low catalyst recovery. Treatment of petroleum coke alone can have very high theoretical carbon conversion (e.g. 98%), but has its own challenges regarding maintaining bed composition, fluidization of the bed in the gasification reactor, control of possible liquid phases and agglomeration of the bed in the gasification reactor and char withdrawal. The process and particulate compositions described herein avoids the above disadvantages and makes possible an economical, and thus commercially viable process for high ash lignites and high sulfur coke.

### EXAMPLES

### Example 1

Lignite—Petroleum Coke Particulate Composition

Samples of a resid petcoke and a higher-ash coal (Beulah, N. Dak.) are obtained and processed as follows. The as-received petroleum coke and/or coal (Beulah, N. Dak.) are jaw-crushed to a free-flowing state, followed by careful stage-crushing to prevent generation of excessive fines and to maximize the amount of material having particle sizes ranging from about 0.85 to about 1.4 mm.

An analysis of the resid petcoke samples provides results as follows: 0.22 percent by weight moisture, 0.28 percent by weight ash (proximate analysis); carbon 88.81 percent, sulfur 5.89 percent and a btu/lb value of 15,210. The ash component of the resid petcoke contains mainly vanadium and nickel oxides with smaller amount of other components.

An analysis of the Beulah, N. Dak. coal samples provides results as follows: 35.58 percent by weight moisture, 20.87 percent by weight ash (proximate analysis); carbon 56.9 percent, sulfur 1.27 percent and a btu/lb value of 6,680. The ash component of the Beulah, N. Dak. coal contains 41.9 percent silica and 16.6 percent alumina, based on the weight of the ash.

Finely ground Beulah, N. Dak. coal is added to an Erlenmeyer flask, and a potassium hydroxide soaking solution is added to the flask forming a slurry. The slurry density is maintained at approximately 20 wt % in the flask. The air inside the flask is displaced with nitrogen and the flask is sealed. The flask is then placed on a shaker bath and is stirred for 4 hours at room temperature. The treated coal is dewatered by filtering over a vibratory screen with a mesh size of about +325 to yield a catalyst-loaded wet coal cake. The catalyst-loaded wet coal cake is kneaded together with the petroleum coke particulate to yield a particulate composition having a 1:1 ratio of the petroleum coke to coal on a dry basis.

The particulate composition comprising a 1:1 blend of the petroleum coke and catalyst-treated Beulah, N. Dak. coal provides results as follows: 10.58 percent by weight ash (proximate analysis); carbon 72.86 percent, sulfur 3.58 percent and a btu/lb value of 12,445. The ash component of the 50/50 blend contains 41.41 percent silica and 16.41 percent alumina, based on the weight of the ash.

### Example 2

Lignite—Petroleum Coke Particulate Composition Gasification

Gasifications of the 1:1 particulate composition from Example 1 and a sample containing only catalyst-treated Beulah, N. Dak. coal are carried out in a high-pressure apparatus that includes a quartz reactor. About a 100 mg of each sample is separately charged into a platinum cell held in the reactor and gasified. Typical gasification conditions are: total pressure, 1.0 MPa; partial pressure of H₂O, 0.21 MPa, in an atmosphere of high purity argon; temperatures, 750° C. to 900° C.; and reaction times, 2 to 3 hr.

Carbon conversions are estimated to be 88.4% for the sample of Example 1 and 71% for the sample containing only catalyst-treated Beulah, N. Dak. coal. Further, the sample of Example 1 is estimated to have a methane production of 21,410 scf/ton as compared to 13,963 scf/ton for the only catalyst-treated Beulah, N. Dak. coal. Catalyst dosage required for the sample of Example 1 is estimated to be 13.5 wt % as compared to 26.6% for a sample of catalyst-treated Beulah, N. Dak. coal.

We claim:

1. A particulate composition having a particle distribution size suitable for gasification in a fluidized bed zone, the particulate composition comprising an intimate mixture of (a) a petroleum coke; (b) a coal; and (c) a gasification catalyst which, in the presence of steam and under suitable temperature and pressure, exhibits gasification activity whereby a plurality of gases comprising methane and one or more of hydrogen, carbon monoxide, carbon dioxide, hydrogen sulfide, ammonia and other higher hydrocarbons are formed, wherein:
(i) the petroleum coke and the coal are present in the particulate composition at a weight ratio of from about 5:95 to about 95:5;
(ii) the gasification catalyst is loaded onto at least the coal;
(iii) the gasification catalyst comprises a source of at least one alkali metal and is present in an amount sufficient to provide, in the particulate composition, a ratio of alkali metal atoms to carbon atoms ranging from 0.01 to about 0.08; and
(iv) the particulate composition comprises a total ash content of less than about 20 wt %, based on the weight of the particulate composition.

2. The particulate composition according to claim 1, where in the alkali metal comprises potassium, sodium or both.

3. The particulate composition according to claim 2, wherein the alkali metal is potassium.

4. The particulate composition according to claim 1, wherein the source of alkali metal is an alkali metal salt selected from the group consisting of carbonate, hydroxide, acetate, halide and nitrate salts.

5. The particulate composition according to claim 1, having a particle size ranging from about 25 microns to about 2500 microns.

6. The particulate composition according to claim 1, wherein the gasification catalyst is loaded only onto the coal.

7. The particulate composition according to claim 1, wherein the gasification catalyst is loaded onto both the coal and the petroleum coke.

8. The particulate composition according to claim 1, wherein the ash content of the particulate composition comprises less than about 20 wt % alumina, based on the weight of the ash.

9. A process for converting a particulate composition into a plurality of gaseous products, the process comprising the steps of:
(a) supplying a particulate composition according to claim 1 to a gasifying reactor;
(b) reacting the particulate composition in the gasifying reactor in the presence of steam and under suitable temperature and pressure to form a plurality of gaseous including methane and one or more of hydrogen, carbon monoxide, carbon dioxide, hydrogen sulfide, ammonia and other higher hydrocarbons; and
(c) at least partially separating the plurality of gaseous products to produce a stream comprising a predominant amount of one of the gaseous products.

10. The process according to claim 9, wherein the stream comprises a predominant amount of methane.

11. The process according to claim 9, wherein a char is formed in step (b), and the char is removed from the gasifying reactor and sent to a catalyst recovery and recycle process.

12. The process according to claim 11, wherein the gasification catalyst comprises gasification catalyst recycled from the catalyst recovery and recycle process.

13. A process for preparing a particulate composition according to claim 1, the process comprising the steps of:
(a) providing petroleum coke particulates, coal particulates and gasification catalyst;
(b) contacting the coal particulates with an aqueous solution comprising gasification catalyst to form a slurry; and
(c) dewatering the slurry to form a catalyst-loaded wet coal cake; and
(d) kneading the wet coal cake and the petroleum coke particulates to form the particulate composition.
